(19) United States
(12) Patent Application Publication
(10) Pub. No.: US 2025/0068806 A1
(43) Pub. Date: Feb. 27, 2025

(54) ADAPTIVE AND DISTRIBUTED SIMULATION OF FLUIDS WITH RIGID BODY COUPLING

(71) Applicant: Roblox Corporation, San Mateo, CA (US)

(72) Inventors: Haoyang SHI, San Mateo, CA (US); Sheldon Paul ANDREWS, San Mateo, CA (US); Kyle Khem CHAND, Livermore, CA (US); Victor B. ZORDAN, Riverside, CA (US)

(73) Assignee: Roblox Corporation, San Mateo, CA (US)

(21) Appl. No.: 18/814,129

(22) Filed: Aug. 23, 2024

Related U.S. Application Data
(60) Provisional application No. 63/534,368, filed on Aug. 24, 2023.

(51) Int. Cl. G06F 30/28; G06F 30/23; G06F 113/08; G06T 17/20

(52) U.S. Cl. CPC G06F 30/28; G06F 30/23; G06T 17/20; G06F 2113/08

(57) ABSTRACT

Some implementations relate to providing adaptive, distributed simulation of fluids with rigid body coupling. According to one aspect, a method simulates, with a coarse resolution on one or more server devices, a global flow field for a fluid within a virtual environment. The method determines regions within the grid to obtain additional detail for, based on the presence of one or more rigid objects within the virtual environment. For each region, the computer-implemented method: assigns client device(s) to the region; sends fluid simulation data pertaining to the region to the client devices; and receives refined fluid simulation data for the region from the client devices. The method replaces the fluid simulation data in the global fluid simulation pertaining to the regions with the refined fluid simulation data for the regions. The method then updates the global flow field for the fluid in real time based on the simulation data.

### CROSS-REFERENCE TO RELATED APPLICATIONS

This application is a non-provisional application that claims priority under 35 U.S.C. § 119(e) to U.S. Provisional Patent Application No. 63/534,368, entitled “SCALABLE AND ADAPTIVE DISTRIBUTED SIMULATION OF FLUIDS WITH RIGID BODY COUPLING,” filed on Aug. 24, 2023, the contents of which are hereby incorporated by reference herein in its entirety.

### TECHNICAL FIELD

Implementations relate generally to the field of computer-based virtual experiences and computer graphics. More specifically, implementations relate to methods, systems and computer readable media for graphically simulating fluids with rigid body coupling in an adaptive, distributed fashion.

### BACKGROUND

The simulation of fluids is useful for a wide variety of computer graphics and virtual experiences, such as interactive virtual reality (VR) applications and video/electronic games. Fluids produce a variety of physical phenomena, such as, e.g., splashing, buoyancy, and viscous drag and lift. The simulation of such physical phenomena can significantly increase the richness, immersion, and realism of virtual experiences in a three-dimensional (3D) environment.

The simulation of large-scale fluids at interactive frame rates is challenging, due to computational costs that increase exponentially with the size and resolution of the simulation. Further, coupling fluids with rigid simulations in order to simulate some of the aforementioned phenomena introduces additional computational overhead.

Fluid simulation for interactive computer graphics is typically performed on a computer with a single central processing unit (CPU) and/or graphics processing unit (GPU). However, low-end devices, such as, e.g., mobile devices and laptop computers, do not have the computational or battery capacity for simulating large and complex scenes. High-end workstations and servers are capable of simulating more complex scenes, but require costly, specialized, dedicated hardware to manage the increased computational demands.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to methods, systems, and computer-readable media for providing adaptive, distributed simulation of fluids with rigid body coupling.

According to one aspect, a computer-implemented method simulates, with a coarse resolution on one or more server devices, a global flow field for a fluid within a virtual environment. The server devices execute a global fluid simulation within the virtual environment, and the global fluid simulation is executed for a grid that represents the virtual environment. An output of the global fluid simulation is a set of fluid simulation data relating to the fluid. A number of regions are determined within the grid to obtain additional detail for, with the determining being based on a presence of one or more rigid objects within the virtual environment. For each of the plurality of regions: one or more client devices from a number of client devices are assigned to the region; the fluid simulation data pertaining to the region is sent from the server devices to the client devices; and refined fluid simulation data for the region is received at the server devices from the client devices. The fluid simulation data in the global fluid simulation pertaining to the regions is replaced with the refined fluid simulation data for the regions. After the replacement, the global flow field for the fluid is updated at the server devices in real time based on the simulation data.

In some implementations, the computer-implemented method includes: identifying one or more overlapping regions with more than one set of the refined fluid simulation data; and interpolating the refined fluid simulation data in the overlapping regions based on residuals of the refined fluid simulation data of the overlapping regions.

In some implementations, assigning one or more client devices to the region is performed based on one or more of: a location of an avatar controlled by a player associated with the client, and a proximity of one or more of the rigid objects to the avatar.

In some implementations, the refined fluid simulation data includes data computed via a local flow field with a finer resolution than the coarse resolution for the global flow field.

In some implementations, the refined fluid simulation data includes data computed via one or more advection operations and divergence-free operations. In some implementations, the advection operations include utilizing a level set to determine fluid boundaries, where the one or more advection operations are within the determined fluid boundaries.

In some implementations, the refined fluid simulation data includes data computed via one or more fluid-rigid coupling effects at a higher spatial resolution than that of the global fluid simulation.

In some implementations, the refined fluid simulation data includes data computed with one or more pressure forces and one or more collision forces of the fluid on the rigid objects based on a geometry and motion of the rigid objects within the region.

In some implementations, the identification of regions to obtain additional detail for is based on one or more of: detecting changes in fluid dynamics, and detecting a proximity of the rigid objects within the virtual environment to one or more points on the grid.

In some implementations, the client devices and the one or more server devices operate according to timesteps, and wherein the client devices execute multiple simulation steps per one server timestep to enable a higher temporal resolution in the local fluid simulations.

In some implementations, computing the refined simulation data includes calculating torque and pressure differentials on the rigid objects based on the fluid simulation data.

According to another aspect, a system includes one or more processors and memory coupled to the one or more processors storing instructions that, when executed by the one or more processors, cause the system to perform operations including simulating, with a coarse resolution on one or more server devices, a global flow field for a fluid within a virtual environment. The server devices execute a global fluid simulation within the virtual environment, and the global fluid simulation is executed for a grid that represents the virtual environment. An output of the global fluid simulation is a set of fluid simulation data relating to the fluid. A number of regions are determined within the grid to obtain additional detail for, with the determining being based on a presence of one or more rigid objects within the virtual environment. For each of the plurality of regions: one or more client devices from a number of client devices are assigned to the region; the fluid simulation data pertaining to the region is sent from the server devices to the client devices; and refined fluid simulation data for the region is received at the server devices from the client devices. The fluid simulation data in the global fluid simulation pertaining to the regions is replaced with the refined fluid simulation data for the regions. After the replacement, the global flow field for the fluid is updated at the server devices in real time based on the simulation data.

According to another aspect, a non-transitory computer readable medium with instructions stored thereon is provided. The instructions stored thereon that, when executed by one or more processors, cause the one or more processors to perform operations. The operations include simulating, with a coarse resolution on one or more server devices, a global flow field for a fluid within a virtual environment. The server devices execute a global fluid simulation within the virtual environment, and the global fluid simulation is executed for a grid that represents the virtual environment. An output of the global fluid simulation is a set of fluid simulation data relating to the fluid. A number of regions are determined within the grid to obtain additional detail for, with the determining being based on a presence of one or more rigid objects within the virtual environment. For each of the plurality of regions: one or more client devices from a number of client devices are assigned to the region; the fluid simulation data pertaining to the region is sent from the server devices to the client devices; and refined fluid simulation data for the region is received at the server devices from the client devices. The fluid simulation data in the global fluid simulation pertaining to the regions is replaced with the refined fluid simulation data for the regions. After the replacement, the global flow field for the fluid is updated at the server devices in real time based on the simulation data.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF DRAWINGS

FIG. 1 is a diagram of an example system architecture for providing adaptive, distributed simulation of fluids with rigid body coupling, in accordance with some implementations.

FIG. 2 is a flow diagram illustrating an example method for providing adaptive, distributed simulation of fluids with rigid body coupling, in accordance with some implementations.

FIG. 3 is a diagram of an example distributed architecture for providing adaptive, distributed simulation of fluids with rigid body coupling, in accordance with some implementations.

FIG. 4 is a diagram illustrating an example of a method for providing adaptive, distributed simulation of fluids with rigid body coupling, in accordance with some implementations.

FIG. 5 is a diagram illustrating an example of an adaptive multigrid structure, in accordance with some implementations.

FIG. 6 is a diagram illustrating an example of a dataflow of a multigrid process used to solve for a divergence-free flow field, in accordance with some implementations.

FIG. 7 is a block diagram that illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

One or more implementations described herein relate to providing adaptive and distributed simulation of fluids with rigid body coupling. In one embodiment, a global flow field for a fluid is simulated, within a virtual environment, with a coarse resolution on one or more server devices. The server devices execute a global fluid simulation within the virtual environment, the global fluid simulation is executed for a grid that represents the virtual environment, and the output of the global fluid simulation is a set of fluid simulation data relating to the fluid. A number of regions within the grid are determined to obtain additional detail for, based on the presence of one or more rigid objects within the virtual environment. For each of the plurality of regions, one or more client devices from a set of client devices are assigned to the region; sends, from the one or more server devices, the fluid simulation data pertaining to the region to the one or more client devices; and receives, at the one or more server devices, refined fluid simulation data for the region from the one or more client devices. The fluid simulation data is replaced in the global fluid simulation pertaining to the regions with the refined fluid simulation data for the regions, and after the replacing, at the one or more server devices, the global flow field for the fluid is updated in real time based on the simulation data. In various embodiments, the technology is utilized in applications such as, e.g., virtual experiences within virtual environments, and game promotions.

In some embodiments, one or more overlapping regions with more than one set of refined fluid simulation data are identified, and the refined fluid simulation data is interpolated in the overlapping regions based on the residuals of the refined fluid simulation data of the overlapping regions.

In some embodiments, one or more of the client devices is assigned to the region is performed based on one or both of: a location of an avatar controlled by a player associated with the client, and a proximity of one or more of the rigid objects to the avatar.

In some embodiments, the refined fluid simulation data includes data computed via a local flow field with a finer grid resolution than the coarse grid resolution for the global flow field.

In some embodiments, the refined fluid simulation data includes data computed via one or more advection and divergence-free operations.

In some embodiments, the one or more advection operations include utilizing a level set to determine fluid boundaries, where the one or more advection operations are within the determined fluid boundaries.

In some embodiments, the refined fluid simulation data includes data computed via one or more fluid-rigid coupling effects at a higher spatial resolution than that of the global fluid simulation.

In some embodiments, the refined fluid simulation data includes data computed with one or more pressure forces and one or more collision forces of the fluid on the rigid objects based on the geometry and motion of the rigid objects within the region.

In some embodiments, the identification of regions to obtain additional detail for is based on one or more of: detecting changes in fluid dynamics, and detecting a proximity of the rigid objects within the virtual environment to one or more points on the grid.

In some embodiments, the client devices and the one or more server devices operate according to timesteps, where the client devices execute multiple simulation steps per one server timestep to enable a higher temporal resolution in the local fluid simulations.

In some embodiments, computing the refined simulation data includes calculating torque and pressure differentials on the rigid objects based on the fluid data.

According to another aspect, a system includes one or more processors and memory coupled to the one or more processors storing instructions that, when executed by the one or more processors, cause the system to perform operations including: simulating, with a coarse resolution on one or more server devices, a global flow field for a fluid within a virtual environment, where the server devices execute a global fluid simulation within the virtual environment, the global fluid simulation is executed for a grid that represents the virtual environment, and the output of the global fluid simulation is a set of fluid simulation data relating to the fluid; and determining a number of regions within the grid to obtain additional detail for, based on the presence of one or more rigid objects within the virtual environment. For each of the plurality of regions, the system performs operations to assign one or more client devices from a set of client devices to the region; send, from the one or more server devices, the fluid simulation data pertaining to the region to the one or more client devices; and receive, at the one or more server devices, refined fluid simulation data for the region from the one or more client devices. The system performs operations to replace the fluid simulation data in the global fluid simulation pertaining to the regions with the refined fluid simulation data for the regions, and after the replacing, performs operations to update, at the one or more server devices, the global flow field for the fluid in real time based on the simulation data.

According to another aspect, a non-transitory computer readable medium with instructions stored thereon is provided. The instructions stored thereon that, when executed by one or more processors, cause the one or more processors to perform operations. The operations include: simulating, with a coarse resolution on one or more server devices, a global flow field for a fluid within a virtual environment, where the server devices execute a global fluid simulation within the virtual environment, the global fluid simulation is executed for a grid that represents the virtual environment, and the output of the global fluid simulation is a set of fluid simulation data relating to the fluid; and determining a number of regions within the grid to obtain additional detail for, based on the presence of one or more rigid objects within the virtual environment. For each of the plurality of regions, the operations include: assigning one or more client devices from a set of client devices to the region; sending, from the one or more server devices, the fluid simulation data pertaining to the region to the one or more client devices; and receiving, at the one or more server devices, refined fluid simulation data for the region from the one or more client devices. The operations further include replacing the fluid simulation data in the global fluid simulation pertaining to the regions with the refined fluid simulation data for the regions, and after the replacing, updating, at the one or more server devices, the global flow field for the fluid in real time based on the simulation data.

Technical advantages of one or more described features can include the ability to perform distributed simulations of fluids with rigid body coupling in a heterogeneous computing environment, particularly in a scalable and adaptive fashion. By dividing the fluid simulation workload between server and client devices, the features enable real-time simulations across multiple platforms, including low-end mobile devices and high-end servers. This allows for efficient resource allocation and optimizes computational load.

Another technical advantage is the method's capacity to maintain high accuracy and consistency in the global fluid simulation while allowing for detailed local simulations on client devices. The use of refined fluid simulation data at higher spatial resolutions enables fluid interactions with rigid objects to be modeled to a higher level of accuracy and realistic behavior of fluids than was previously possible in prior approaches. This feature particularly improves upon accuracy in applications like virtual reality or multiplayer games, a quality which is important for immersion and user experience.

Another technical advantage is improved communication efficiency between server and client devices. By selectively transmitting only the necessary fluid simulation data for regions requiring refinement, the techniques reduce the amount of data exchanged over the network, minimizing bandwidth usage and latency. The techniques are important for environments with limited network resources or where real-time interaction is critical, as it enables smooth and uninterrupted simulation performance in such situations.

Another technical advantage is improved continuity and divergence-free fluid simulations in overlapping regions where multiple client devices contribute refined data. By employing interpolation techniques based on residuals from the refined simulations, conflicts can be managed, and continuity and divergence-free properties of the global flow field can be maintained. This enables the global fluid simulation to remain realistic and physically plausible, even when multiple users or devices are interacting with the same fluid region.

Another technical advantage is the ability to execute multiple simulation steps per server timestep on client devices. This allows for higher temporal resolution in the local fluid simulations, which in turn leads to more responsive and dynamic fluid behavior. The technique allows for real-time applications that require quick updates and fluid interaction feedback. The higher temporal resolution also contributes to the overall realism and fidelity of the simulation, allowing for interactive simulations.

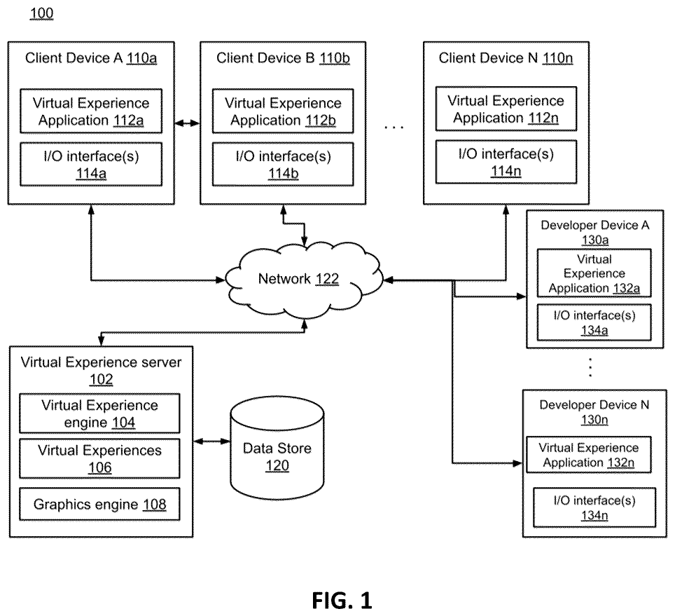

### FIG. 1—System Architecture

FIG. 1 is a diagram of an example system architecture that can be used to provide mesh retopology for improved animation of three-dimensional avatar heads, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

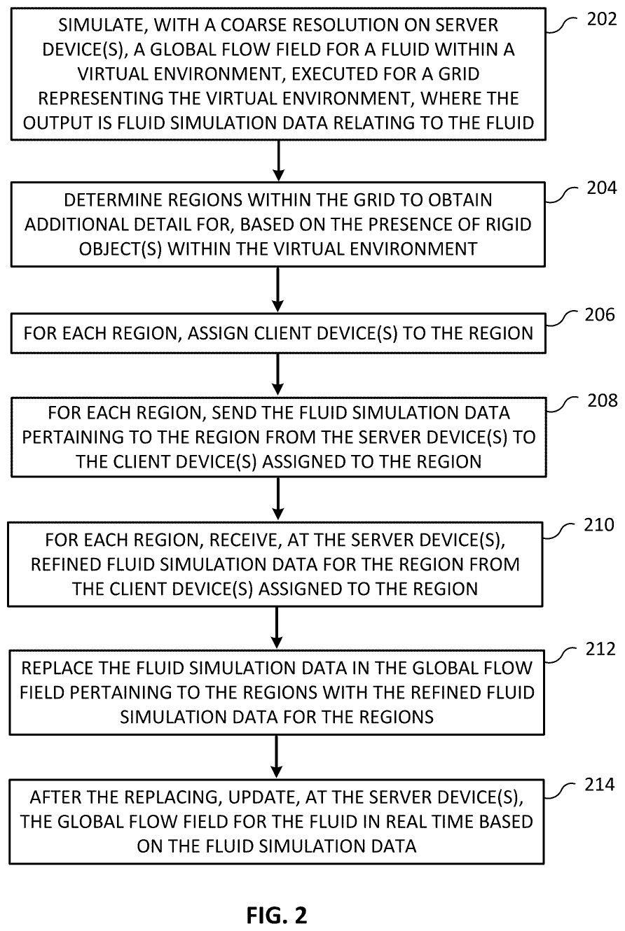

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowchart shown in FIG. 2. In one or more additional or alternative implementations, the operations described below may be performed on one or more client devices 110, or one or more developer devices 130. In some implementations, where the operations are performed depends at least in part on compute resources, e.g., memory, processing power, or disk space. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be or include a virtual gaming server. For example, the gaming server may provide single-player or multiplayer games to a community of users that may access a “system” herein that includes online gaming server 102, data store 120, and client device 110 and/or may interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of a virtual environment may be a three-dimensional (3D) environment. The one or more environments of a virtual experience 106 may be collectively referred to as a “world” or “virtual experience world” or “gaming world” or “virtual world” or “virtual space” or “universe” herein. An example of a world may be a 3D world of a virtual experience 106. For example, a user may build a virtual environment that is linked to another virtual environment created by another user. A character (avatar) of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters (avatars), decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character (avatar) within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc.

One or more characters (also referred to as an “avatar” or “model” herein) may be associated with a user where the user may control the character to facilitate a user's interaction with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, animate or inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 130 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or engage in virtual experiences 106 hosted by online virtual experience server 102). As such, the virtual experience application may be provided to the client device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, which are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (hereinafter “APIs”), and thus is not limited to use in websites.

FIG. 2 is a flow diagram illustrating an example method for providing adaptive, distributed simulation of fluids with rigid body coupling. in accordance with some implementations. In various embodiments, the blocks shown in FIG. 2 and described below may be performed by any of the elements illustrated in FIG. 1.

At block 202, a global flow field for a fluid within a virtual environment is simulated, with a coarse resolution, on one or more server devices. In some implementations, the simulation of the global flow field is executed for a grid representing the virtual environment, where the output is fluid simulation data relating to the fluid. In some implementations, the grid consists of a three-dimensional array of cells, with each cell storing information such as, e.g., fluid velocity, pressure, and other properties of the fluid. The coarse resolution of the grid enables each cell to correspond to a larger volume of fluid. This allows the global flow field to capture macroscopic behavior of the fluid across the environment.

In various implementations, the grid can be structured in different ways depending on the requirements of the simulation, the nature of the virtual environment, and the computational resources available. In some implementations, the grid is uniform, meaning that each cell has the same dimensions (i.e., a regular grid). However, in other implementations, the grid may be non-uniform, with cells varying in size to provide higher resolution in regions of particular interest, such as near boundaries, interfaces, or regions with significant fluid activity. In some implementations, the grid can be structured as a Cartesian grid, where cells are aligned along the x, y, and z axes. In other implementations, the grid can be structured as an adaptive mesh refinement (AMR) grid that dynamically adjusts its resolution based on the fluid's behavior.

The coarse resolution of the grid refers to the relatively large size of each cell at a global scale, which allows each cell to encompass a larger volume of fluid. This coarser discretization at the global scale reduces the total number of cells needed to cover the entire virtual environment, thereby reducing the computational resources required for the global fluid simulation. Despite the lower resolution, the grid is sufficient to capture the macroscopic behavior of the fluid, such as, e.g., large-scale flow patterns, wave propagation, and overall fluid dynamics, while finer details are addressed in subsequent steps of the method, as will be described in further detail below.

In some implementations, each cell within the grid stores discrete values for the physical properties of the fluid at that location, such as, e.g., velocity, pressure, and density. These discrete values are updated at regular intervals during the simulation, referred to as timesteps. A timestep represents a small, discrete increment of time over which the state of the fluid is calculated and advanced. During each timestep, the fluid simulation solves the governing equations of fluid dynamics to predict how the fluid's properties will change within each cell.

In some implementations, where the grid is adaptive or hierarchical, the resolution of the grid may vary across the domain. In regions where the fluid behavior is less complex or where large-scale phenomena dominate, the grid cells may remain coarse. Conversely, in regions where more detailed simulation is necessary, the grid may be refined, with cells subdivided into smaller cells to increase the resolution. This adaptive approach allows the simulation to allocate computational resources more effectively, concentrating detail where it is needed most, without compromising the efficiency of the global simulation.

In some implementations, the global fluid simulation, which is executed at a coarse resolution, models large-scale fluid movements including, for example, waves, currents, and eddies. The simulated global flow field establishes a base layer for representing fluid dynamics within the virtual environment.

In some implementations, the global fluid simulation utilizes a multigrid solver to address the governing fluid dynamics equations, such as, for example, Navier-Stokes equations, across the coarse grid. In some implementations, the multigrid method is employed to solve the Poisson equation for pressure correction, which is utilized for maintaining a divergence-free velocity field. The server converges on a solution that satisfies the incompressibility condition of the fluid, ensuring that the simulated flow field remains physically accurate at the coarse resolution. The output of the simulation consists of fluid simulation data representing the global flow characteristics within the virtual environment. Block 202 may be followed by block 204.

At block 204, regions within the grid are determined that require additional detail, based on the presence of one or more rigid objects within the virtual environment. In some implementations, this determination process involves analyzing the positions and movements of rigid objects, such as, for example, characters, vehicles, or other interactive or non-interactive elements within the virtual environment, relative to the grid cells that represent the fluid domain. Examples of such rigid objects may include a boat moving through water, an avatar representing a player character wading through a shallow fluid, or a stationary structure like a pier or bridge. In some implementations, the locations of these rigid objects are used to identify specific grid regions where fluid-rigid interactions are likely to occur. These regions are identified for further processing, as they are expected to exhibit complex fluid dynamics that cannot be sufficiently captured by the coarse global grid.

In some implementations, the process of determining these regions begins by mapping the rigid objects' positions within the virtual environment onto the grid. Each rigid object is associated with one or more grid cells based on its spatial extent and orientation. The grid cells that correspond to the boundaries and immediate surroundings of these objects are flagged for refinement. In some implementations, this refinement is based on the expected interaction between the fluid and the rigid objects, where the presence of obstacles or moving bodies within the fluid can cause local changes in, e.g., pressure, velocity, and other fluid properties. The determination algorithm uses the physical properties and movement patterns of the rigid objects to select regions where the grid resolution will be increased.

In some implementations, the determination of regions requiring additional detail may also take into account the fluid properties and flow characteristics in the vicinity of the rigid objects. For example, areas where the fluid is expected to experience significant shear, turbulence, or rapid changes in flow direction due to the presence of a rigid object may be marked for grid refinement. This process can involve computing the local flow field around the rigid objects and analyzing the gradient of velocity or pressure fields to identify regions where higher resolution is necessary.

In some implementations, the refinement regions are dynamically adjusted throughout the simulation as the rigid objects move within the virtual environment. As objects interact with the fluid and alter the flow field, the regions requiring additional detail may shift or expand. In some implementations, the system continuously monitors the positions of the rigid objects and the resulting fluid interactions to update the grid regions designated for refinement. This allows the simulation to adapt in real-time to changes in the virtual environment, maintaining accurate fluid-rigid coupling as the simulation progresses.

In some implementations, the identification of regions for refinement is based on detecting the proximity of rigid objects within the virtual environment to specific points on the grid. In some implementations, the server devices continuously track the positions and movements of rigid objects, such as vehicles, characters, or obstacles, relative to the grid cells. When a rigid object is detected to be in close proximity to one or more grid points, the corresponding region is marked for refinement. This proximity-based refinement is used for capturing the interactions between the fluid and the rigid objects, as the fluid properties near these objects are likely to experience significant perturbations. Block 204 may be followed by block 206.

At block 206, for each region identified for refinement, one or more client devices are assigned to the region. In various implementations, this assignment of client devices is based on one or more factors, which may include, e.g., the location of the region within the virtual environment, the proximity of a playable character controlled at the client device to the region or rigid objects within the region, and the computational resources available on the client device. Client devices may include a wide range of hardware, such as, e.g., personal computers, gaming consoles, mobile phones, tablets, or any other devices capable of executing fluid simulations and processing the relevant data. These devices may vary in processing power, memory, and graphical capabilities, which can influence the decision on which device to assign to a particular region.

In some implementations, the assignment process involves identifying the client devices that are closest to the region of interest within the virtual environment. For example, if a region involves a fluid interaction near a player-controlled avatar, the client device associated with that player may be assigned to handle the simulation for that region. This proximity-based assignment allows the client device to focus on regions that are immediately relevant to its user's perspective.

In some implementations, the assignment of client devices may also be determined at least in part by the computational load and capabilities of each device. For example, a gaming console with a high-performance GPU may be assigned more computationally intensive regions, such as those involving complex fluid-rigid interactions or high-resolution simulations, while a mobile phone with limited processing power may be assigned less demanding regions or may work in conjunction with other devices. The system may dynamically distribute the workload across multiple client devices based on real-time assessments of each device's available resources.

In some implementations, with scenarios involving multiple client devices assigned to the same, overlapping, or adjacent regions, the system coordinates the distribution of the simulation tasks among the devices to avoid redundant computations and ensure consistency across the region boundaries. When client devices are assigned overlapping regions, the system may define specific subregions or layers of the simulation domain that each device is responsible for. These overlapping assignments may be used to increase the resolution of the simulation in critical areas or to distribute the computational load among several devices. The system may implement a priority scheme where one device is designated as the primary simulator for a particular overlap region, while other devices may perform supplementary calculations, such as refining boundary conditions or enhancing specific aspects of the simulation, like turbulence or fine-scale interactions.

For example, two client devices assigned to simulate overlapping regions may share data at the boundary cells and within the overlapping volume to maintain continuity in the simulation and ensure that the fluid properties, such as, e.g., velocity and pressure, are consistent across the shared area. This shared data may include, e.g., velocity vectors, pressure values, and other fluid properties, which are exchanged between the devices at regular intervals or at the end of each timestep. Interpolation methods or averaging techniques may be used to merge the simulation results from overlapping regions, ensuring that the final output remains physically accurate and coherent.

In some implementations where the overlapping regions involve complex interactions between fluids and multiple rigid objects, the system may assign specific simulation tasks, such as fluid-rigid coupling calculations or advection processes, to different devices based on their computational strengths. This division of labor allows for more detailed and accurate simulations within the overlapping regions, with the system integrating the results to form a unified simulation output. Conflict resolution strategies may also be implemented in cases where different devices produce conflicting simulation data for the same region, such as using a weighted average based on the confidence levels of each device's computations or prioritizing data from the device with higher computational accuracy.

In some implementations, the assignment process further accounts for potential issues such as device disconnection or failure. If a client device responsible for an overlapping region disconnects or fails during the simulation, the system dynamically reallocates the region to another available device or devices, redistributing the computational tasks to maintain the integrity and continuity of the simulation. The reassignment process ensures that the simulation remains robust and that all regions, including overlapping areas, are continuously simulated without interruption.

In some implementations, the assignment process is based on the location of an avatar controlled by a player associated with the client device. This process begins by determining the spatial coordinates of the avatar within the virtual environment. In some implementations, the avatar's position is continuously tracked and mapped onto the corresponding cells within the grid that represents the fluid domain. The server devices analyze the proximity of the avatar to the identified regions that require additional refinement, using this information to assign the client device associated with the player to the appropriate region. In some implementations, this assignment is dynamic and may change as the avatar moves within the virtual environment.

In some implementations, the assignment process takes into account the proximity of one or more rigid objects within the virtual environment to the avatar. The server devices evaluate the spatial relationship between the avatar and nearby rigid objects, which may include obstacles, structures, or other interactive elements. These objects influence the fluid dynamics within the region, and the region is of particular interest to the player's perception of the fluid dynamics if the objects are in close proximity to the avatar of the player. In some implementations, the assignment of client devices to regions is prioritized where the avatar is near or interacting with these rigid objects, as this proximity often correlates with areas where detailed fluid-rigid interactions need to be simulated.

In some implementations, the server devices use the combined data on avatar location and rigid object proximity to make informed decisions about which client devices are most appropriate for simulating specific regions. The decision-making process involves evaluating the computational capabilities of the client devices in conjunction with their relevance to the region based on the avatar's activities. For example, a client device controlling an avatar that is closely interacting with a complex fluid-rigid scenario, such as navigating a boat through turbulent water, may be assigned to simulate the corresponding region to provide a detailed and accurate local simulation. The server may also assign multiple client devices to a region if the avatar's movements or the presence of rigid objects warrant a higher level of detail or computational power. In some implementations, the assignment process is continuously updated as the avatar and rigid objects move within the virtual environment. The server devices monitor these movements in real time, reassigning regions to different client devices as necessary to maintain optimal simulation performance.

In some implementations, the synchronization of operations between the client devices and the one or more server devices is based on discrete timesteps. The server devices operate on a global timestep, which is used to advance the simulation of the global flow field at a coarse resolution. The client devices, which are responsible for refining specific regions of the simulation, operate on a local timestep that may differ from the global timestep used by the server devices. In some implementations, the client devices are configured to execute multiple simulation steps within each global timestep defined by the server devices. This means that while the server devices update the global flow field once per global timestep, the client devices perform several smaller, more frequent updates within the same period. These multiple local timesteps allow the client devices to capture rapid changes in fluid dynamics within their assigned regions, which may be necessary for accurately simulating interactions between the fluid and nearby rigid objects or for resolving fine-scale phenomena such as turbulence or wave breaking. In some implementations, the execution of multiple local simulation steps per global timestep involves subdividing the global timestep into smaller intervals, each corresponding to a local timestep on the client devices. During each local timestep, the client devices perform the necessary computations to advance the state of the fluid within their refined regions. This includes updating velocity fields, pressure distributions, and other relevant fluid properties, as well as resolving any fluid-rigid coupling effects or boundary interactions that occur within the region. The results of each local timestep are accumulated, and the final state of the fluid at the end of the global timestep is transmitted back to the server devices.

In some implementations, with respect to the timesteps, each client operates asynchronously, meaning that they run on their own individual clock. This asynchronous operation allows each client to perform simulation steps independently, without needing to synchronize their progression with other clients. In some implementations, when the server collects updates from the clients, it waits until all client updates have been received before proceeding. Once all updates are collected, the server then merges this information to form a cohesive update to the global simulation. This merging process involves integrating the various data points and resolving any discrepancies that may arise due to the asynchronous nature of the client operations. Block 206 may be followed by block 208.

At block 208, for each region, the fluid simulation data pertaining to the region is sent from the one or more server devices to the one or more client devices assigned to the region. In some implementations, this transmission involves selecting the relevant subset of the global fluid simulation data that corresponds to the spatial extent of the designated region within the virtual environment. This data may include, for example, the values for fluid velocity, pressure, and other relevant physical properties stored in the cells of the grid that fall within or are adjacent to the defined region. In some implementations, the server devices package this data into a format suitable for transmission, accounting for the spatial layout and the resolution of the grid at the coarse level.

In some implementations, the server devices then initiate the data transfer to the assigned client devices using one or more available communication channels. In some implementations, the transmission process may involve the use of network protocols designed to handle real-time data exchange, such as, e.g., Transmission Control Protocol (TCP) or User Datagram Protocol (UDP), depending on the network conditions and the required data integrity. In some implementations, the data is compressed prior to transmission to reduce the bandwidth required and to expedite the transfer process, especially in scenarios involving large regions or high-resolution data sets. The compression technique may involve lossless algorithms to preserve the accuracy of the fluid properties being transmitted.

In various implementations, the data transfer may be executed in a sequential or parallel manner, depending on the number of client devices assigned to each region and the complexity of the fluid simulation data. For regions assigned to multiple client devices, the server may distribute different portions of the region's data to each device, or it may replicate the same data across multiple devices to support parallel processing. The server devices monitor the status of the transmission to ensure that the data is successfully received by the client devices. Error-checking mechanisms, such as checksums or acknowledgment signals, may be used to verify the integrity of the data after transmission, with retransmissions initiated if errors are detected.

In some implementations, upon receiving the fluid simulation data, the client devices unpack the data and prepare it for local simulation processing. The data is mapped onto the finer grid resolution used by the client devices for their respective regions, where it serves as the initial condition for the localized fluid simulations. The client devices may also integrate this data with their existing simulation state if the data transfer occurs mid-simulation. This process of data transmission and integration is repeated for each timestep or simulation update cycle, enabling the client devices to perform detailed simulations based on the most current state of the fluid as modeled by the server devices. Block 208 may be followed by block 210.

At block 210, for each region, the one or more server devices receive refined fluid simulation data from the one or more client devices assigned to the region. The refined data represents the results of localized simulations conducted by the client devices, which have processed the fluid dynamics at a finer resolution within their designated regions. In various implementations, this data may include updated values for one or more of, e.g., velocity, pressure, vorticity, and other fluid-related properties that have been calculated based on the more detailed grid and advanced simulation techniques employed by the client devices.

In some implementations, the transmission of refined data from the client devices to the server devices is managed through established network communication channels, using protocols suited to the simulation's real-time requirements. The client devices transmit their simulation results for the assigned regions in a structured format. In some implementations, this may include, e.g., metadata indicating the spatial coordinates, timestep, and resolution of the refined data. In some implementations, the server devices receive this data and verify its completeness and integrity through standard data validation techniques, such as checksums or error detection codes. In some implementations, the server may request retransmission of data packets that are found to be incomplete or corrupted during the transmission process.

In some implementations, the refined fluid simulation data within each region includes data computed via one or more advection operations. Advection refers to the transport of fluid properties, such as, e.g., velocity, temperature, or concentration, through the grid due to the motion of the fluid. In this process, the fluid's velocity field is used to update the values of these properties within the grid cells as the fluid moves through the virtual environment. In some implementations, the client devices execute the advection step by solving the advection equation for each cell. In various implementations, this solving involves using numerical methods such as, for example, upwind schemes, semi-Lagrangian methods, or higher-order finite difference methods.

In some implementations, a level set method (LSM) is used to determine fluid boundaries within the region during the execution of advection operations. The LSM represents the interface or boundary between different phases of the fluid, such as the boundary between liquid and air, by embedding it within a higher-dimensional scalar function known as the level set function. In this context, the level set function is defined such that its zero level contour corresponds to the fluid boundary. The values of the level set function are positive on one side of the boundary (typically inside the fluid) and negative on the other side (outside the fluid), allowing the client devices to precisely track the position and shape of the fluid interface as it evolves over time. During advection, the client devices update the level set function by advecting it with the velocity field of the fluid. This process involves solving the level set equation, a partial differential equation that governs the motion of the interface. In various implementations, numerical methods such as upwind schemes or the semi-Lagrangian approach are employed to solve this equation, ensuring that the level set function evolves in a manner consistent with the underlying fluid flow. By updating the level set function, the client devices continuously track the changing fluid boundaries, enabling accurate advection of fluid properties only within the region defined by the interface. In some implementations, the advection operations are then confined to the regions within the determined fluid boundaries as defined by the level set function. This selective advection process ensures that fluid properties such as velocity, pressure, and density are updated only within the fluid domain, avoiding unnecessary computations in regions that do not contain fluid. The level set function is utilized by the advection solver to focus on cells within the fluid while ignoring cells outside the interface.

In some implementations, the refined simulation data includes data computed via one or more divergence-free operations, ensuring that the velocity field remains divergence-free. This is a condition necessary for maintaining the incompressibility of the fluid. A divergence-free velocity field means that the fluid's volume does not change as it moves, which is a characteristic of incompressible fluids. In some implementations, to enforce this condition, the client devices perform a pressure projection step, where they solve a Poisson equation for the pressure field. The solution to this equation is then used to adjust the velocity field so that the divergence at each grid cell is minimized or eliminated.

In some implementations, the computation of the divergence-free velocity field is carried out using numerical solvers that are designed to handle the specific requirements of the fluid simulation. In various implementations, the Poisson equation is solved using iterative methods such as, for example, the conjugate gradient method, multigrid solvers, or other appropriate techniques that can efficiently converge to a solution within the grid's resolution. The resulting pressure field is used to correct the velocity field across the entire region. In some implementations, this process is repeated iteratively within each timestep to achieve the desired level of accuracy in the simulation.

In some implementations, the refined fluid simulation data includes data computed via one or more fluid-rigid coupling effects at a higher spatial resolution than that of the global fluid simulation. Fluid-rigid coupling refers to the bidirectional exchange of forces and momentum between the fluid and solid objects within the simulation domain. In some implementations, to achieve this, the client devices perform detailed calculations that account for the influence of the fluid on the motion of rigid bodies and, conversely, the impact of rigid bodies on the fluid flow. This process involves solving coupled differential equations that govern the dynamics of both the fluid and the rigid bodies.

In some implementations, the client devices use a refined grid that provides a higher spatial resolution compared to the global simulation, allowing for more detailed representation of the fluid-rigid interactions. In various implementations, the refined grid enables the simulation to capture small-scale effects such as, for example, the precise pressure distribution on the surface of the rigid bodies, localized vortices generated by fluid flow around obstacles, and the detailed deformation of fluid surfaces in response to the motion of the rigid bodies. In various implementations, numerical methods such as, for example, immersed boundary methods, finite element methods, or lattice Boltzmann methods may be employed to handle the complex geometry of the rigid bodies and to solve the fluid-rigid coupling equations at the finer resolution. In some implementations, the fluid-rigid coupling effects are computed by first determining the forces exerted by the fluid on the rigid bodies, such as, e.g., drag, lift, and pressure forces. These forces are calculated based on the fluid properties at the fluid-solid interface, where the refined grid allows for accurate resolution of the interaction forces. The resulting forces and torques are then used to update the motion of the rigid bodies, such as, for example, their velocities, angular momentum, and positions. Conversely, the movement and orientation of the rigid bodies may affect the surrounding fluid, altering the local velocity and pressure fields. In some implementations, this bidirectional interaction is resolved iteratively within each timestep, with the refined grid providing the necessary spatial detail to accurately model the coupled dynamics.

In some implementations, the refined fluid simulation data includes data computed with one or more pressure forces and one or more collision forces of the fluid on the rigid objects based on the geometry and motion of the rigid objects within the region. In some implementations, these forces are calculated based on the interaction between the fluid and the rigid objects, taking into account the geometry and motion of the objects. The pressure forces are generated by the fluid's pressure field acting on the surfaces of the rigid bodies, while collision forces arise when the fluid flow is disrupted by the movement or presence of the rigid bodies, leading to impacts or changes in momentum. In some implementations, to compute the pressure forces, the client devices first resolve the fluid pressure field at the interface between the fluid and the rigid objects. The pressure at each point on the surface of a rigid object is determined using the refined grid, which allows for a detailed representation of the pressure distribution. The client devices then integrate these pressure values over the surface area of the rigid object to obtain the net force and torque exerted by the fluid on the object. In some implementations, this process takes into account the object's geometry, as the shape and surface features of the rigid body influence how pressure forces are distributed and applied. In addition to pressure forces, the method also involves calculating collision forces that occur when the fluid flow interacts with the rigid objects in a way that causes abrupt changes in momentum. In some implementations, these collision forces are computed by analyzing the velocity field of the fluid in the vicinity of the rigid objects and identifying regions where the fluid experiences sudden deceleration, acceleration, or redirection due to the presence or motion of the objects. In some implementations, the client devices apply momentum conservation principles to quantify the impact forces, considering both the mass and velocity of the fluid elements involved in the collision.

In some implementations, the refined simulation data includes calculated torque and pressure differentials on the rigid objects based on the fluid data. Torque, in this context, refers to the rotational force applied to the rigid objects as a result of the fluid's interaction with the surfaces of these objects. Pressure differentials arise due to variations in the fluid pressure at different points on the surface of the rigid object, leading to net forces that influence both the linear and angular motion of the object. In some implementations, the calculation of torque on a rigid object begins by resolving the fluid velocity and pressure fields in the vicinity of the object's surface using the refined grid. The client devices then determine the pressure at discrete points along the object's surface, accounting for both the local fluid dynamics and the geometry of the object. The torque is computed by integrating the cross product of the position vector (relative to the object's center of mass) and the pressure-induced force over the entire surface of the object. This integration yields the total torque, which dictates the object's rotational response to the fluid forces. In some implementations, pressure differentials are determined by comparing the pressure values at different points on the object's surface. These differentials are directly related to the net force exerted by the fluid on the object. The client devices compute these differentials by resolving the pressure gradient across the object's surface, which involves subtracting the pressure at one point from the pressure at another. The resulting force vectors are then integrated over the surface to calculate the total linear force acting on the object. Block 210 may be followed by block 212.

At block 212, the fluid simulation data in the global flow field pertaining to the regions is replaced with the refined fluid simulation data for the regions. This replacement process involves updating the global grid with the higher-resolution data that has been computed locally by the client devices. In some implementations, the server devices first identify the specific cells or subregions within the global grid that correspond to the regions for which refined data has been received. These cells, which initially contained the coarse resolution simulation data, are targeted for substitution with the newly obtained refined data.

In some implementations, the process of replacing the data begins with mapping the refined simulation data from the client devices onto the corresponding locations within the global grid. The server devices align the spatial coordinates of the refined data with the existing grid cells, ensuring that each data point from the client simulations is accurately placed within the global context. This may involve directly substituting values for fluid properties such as, e.g., velocity, pressure, and density in the corresponding cells of the global grid.

In some implementations, the server may interpolate between the refined data and the surrounding coarse data to maintain a smooth transition between regions of differing resolutions. In some implementations, the interpolation process is employed by the server to facilitate a smooth transition between the refined data, which has been received from the client devices, and the surrounding coarse data within the global flow field. In some implementations, the interpolation process involves calculating intermediate values for fluid properties, such as velocity, pressure, and density, in the transition zone between the refined and coarse regions. These intermediate values are derived from both the refined data provided by the client devices and the existing coarse data that resides in adjacent cells. In various implementations, the interpolation may be conducted using various methods depending on the desired accuracy and computational resources available. In some implementations, the approach involves linear interpolation, where the values in the transition zone are computed as weighted averages of the neighboring refined and coarse values. For example, the velocity at a boundary cell might be interpolated by taking a linear combination of the velocity in the nearest refined cell and the velocity in the nearest coarse cell, with weights assigned based on the proximity of the boundary cell to each region. In some implementations, this method can be extended to higher-order interpolation techniques, such as cubic interpolation, which takes into account additional neighboring cells to produce a smoother gradient across the transition zone.

In some implementations, the interpolation process may also incorporate aspects of the physical dynamics of the fluid, ensuring that the interpolated values not only maintain continuity but also reflect the correct physical behavior of the fluid. For example, if the fluid is subject to conservation laws, such as the conservation of mass or momentum, the interpolation method may be adjusted to ensure that these laws are respected across the boundary. This might involve solving additional equations or applying constraints to the interpolation algorithm, such that the interpolated values satisfy the same governing equations as those used in the coarse and refined simulations.

Once the refined data is mapped onto the global grid, the server devices proceed to overwrite the existing fluid simulation data in the relevant regions. This step replaces the coarse data with the refined data for each cell within the identified regions, effectively updating the global flow field to reflect the higher-resolution calculations performed by the client devices. In some implementations, the replacement operation is performed in a manner that preserves the continuity of the simulation across the entire grid, ensuring that the global flow field remains consistent and physically accurate after the update.

In some implementations, the server devices may apply boundary conditions to the edges of the refined regions to ensure that the integration with adjacent coarse regions is seamless. These boundary conditions may include, for example, setting fixed values, such as a no-slip condition for velocity, or applying gradient-based conditions that ensure the fluid properties change smoothly across the boundary. In some implementations, the server may additionally enforce conservation laws, such as mass or energy conservation, at the boundary to maintain physical consistency between the refined and coarse regions, preventing one or more artifacts or inaccuracies in the global simulation.

In some implementations, the replacement process includes identifying one or more overlapping regions within the global flow field where multiple client devices have generated and submitted refined fluid simulation data. These overlapping regions occur when the spatial extents of the regions assigned to different client devices intersect, resulting in multiple sets of refined data for the same grid cells. The server devices first map the refined data sets to the global grid, identifying the cells that are affected by contributions from more than one client device. In some implementations, the identification process involves comparing the spatial coordinates and extents of the refined regions to detect areas where overlap occurs, allowing the system to flag these regions for further processing.

In some implementations, once the overlapping regions have been identified, the server devices proceed to analyze the refined fluid simulation data associated with each region. In some implementations, the analysis includes extracting the relevant physical properties, such as velocity, pressure, and vorticity, from each overlapping data set. The server devices then calculate the residuals of these properties by determining the differences between the values provided by the different client devices. These residuals serve as indicators of the discrepancies between the overlapping data sets, which may arise due to variations in the local simulations performed by the different client devices. The server devices store the residuals for use in the subsequent interpolation process. In some implementations, an interpolation process is applied to the overlapping regions to reconcile the differences in the refined fluid simulation data. The server devices utilize the residuals to guide the interpolation, ensuring that the final values of the fluid properties in the overlapping regions represent a combination of the input data sets. In some implementations, the interpolation method may involve linear or higher-order interpolation techniques, where the final values are computed as weighted averages of the contributions from the different client devices. In some implementations, the weights assigned to each data set during interpolation are based on the magnitude of the residuals, with smaller residuals typically receiving higher weights to prioritize the more consistent or accurate data. Block 212 may be followed by block 214.

At block 214, after the replacing, the global flow field for the fluid is updated at the one or more server devices in real time based on the fluid simulation data. In some implementations, this update process involves recalculating the global fluid dynamics to reflect the newly integrated refined data and ensuring that the global simulation remains consistent with the physical laws governing fluid behavior. The server devices use the updated values of velocity, pressure, and other fluid properties from both the refined and coarse regions to advance the simulation to the next timestep. The recalculated global flow field represents the current state of the fluid within the virtual environment, with all regions, both refined and coarse, contributing to the overall dynamics.

In some implementations, the real-time update of the global flow field involves solving the governing equations of fluid dynamics, such as, e.g., the Navier-Stokes equations, across the entire grid. The server devices apply numerical methods, such as, e.g., finite difference, finite volume, or finite element methods, to compute the new state of the fluid based on the current simulation data. In some implementations, this computation may include, for example, advection, diffusion, and the application of external forces, as well as pressure correction steps to maintain incompressibility. The updated global flow field accounts for the interactions between refined regions and the surrounding coarse regions, ensuring that fluid properties such as velocity and pressure are smoothly distributed across the entire grid.

In some implementations, the server devices may also perform one or more additional computations to address any discrepancies or inconsistencies that may arise during the integration of refined data. For example, the server may detect and correct for any numerical instabilities that occur due to sharp gradients or complex interactions within the fluid. In some implementations, this may involve applying smoothing techniques or adjusting the timestep size to maintain the stability of the global simulation. The server devices may also update boundary conditions based on the new fluid state, recalculating interactions with rigid objects, terrain, or other environmental factors within the virtual environment.

In some implementations, once the global flow field has been updated, the server devices store the new fluid simulation data and prepare it for the next cycle of simulation. The updated global flow field serves as the basis for future refinements, allowing the system to continue adjusting the fluid simulation in response to changes within the virtual environment. This iterative process of updating and refinement enables the server devices to maintain a real-time simulation of the fluid that accurately reflects the ongoing interactions and dynamics within the virtual environment. In various implementations, the updated data is then used to drive visualizations, interactions, and any other elements within the environment that depend on the fluid's behavior, ensuring that all aspects of the simulation remain consistent with the current state of the global flow field.

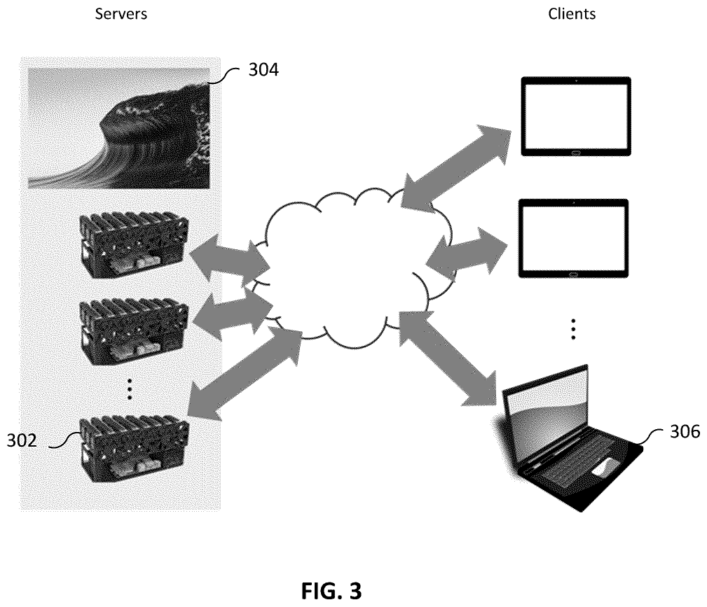

FIG. 3 is a diagram of an example distributed architecture for providing adaptive, distributed simulation of fluids with rigid body coupling, in accordance with some implementations. The diagram illustrates the flow of data and computational processes across a heterogeneous computing environment, which includes both high-end server devices and lower-end client devices, such as mobile phones, tablets, and laptops. This architecture is designed to handle large-scale fluid simulations while maintaining interactivity and responsiveness within regions of interest, particularly where detailed fluid-rigid interactions occur.

On the left side of FIG. 3, a series of server devices 302 are depicted, each represented by high-performance computing hardware, symbolized by the multiple rows of processors. These server devices 302 are responsible for executing the global fluid simulation 304, which operates on a coarse grid that encompasses the entire virtual environment. The global simulation 304 processes large-scale fluid dynamics, including, for example, wave propagation and the overall flow field, and maintains the necessary boundary conditions to ensure fluid consistency across the environment. The simulation data generated by these servers is then made available to client devices 306 through a distributed network.

The diagram also illustrates the interaction between the global servers 302 and client devices 306, which are connected through a network represented by the central cloud. This network facilitates the transmission of data between the servers 302 and clients 306, enabling the distributed and adaptive refinement of fluid simulations. The arrows indicate the flow of data, with the servers 302 sending subsets of the global fluid data, particularly regions requiring refinement, to the client devices 306. This data includes key fluid properties such as, e.g., velocity, pressure, and other dynamic characteristics that need to be simulated at a finer resolution.

On the right side of the diagram, various client devices 306 are depicted, including a laptop and several mobile devices. These client devices receive the simulation data from the servers and perform localized, high-resolution fluid simulations in the regions assigned to them. The client simulations focus on regions where additional detail is required, such as around rigid bodies or other interactive elements. The client devices 306 execute these simulations independently and asynchronously, allowing them to adapt to the specific computational capabilities of each device. The results of these local simulations, which include refined fluid-rigid coupling data, are then transmitted back to the servers 302.

The diagram emphasizes the bidirectional flow of data between the servers 302 and client devices 306. After completing the local simulations, the client devices 306 send the refined simulation data back to the servers 302. This data is used to update the global flow field, with the servers 302 performing additional processing, such as interpolating overlapping regions or aggregating data from multiple clients. The servers 302 then integrate this refined data into the global simulation, ensuring that the updated fluid dynamics are reflected across the entire virtual environment. The continuous exchange of data between the servers 302 and clients 306 supports a scalable and adaptive simulation framework that can handle complex fluid-rigid interactions in real-time.

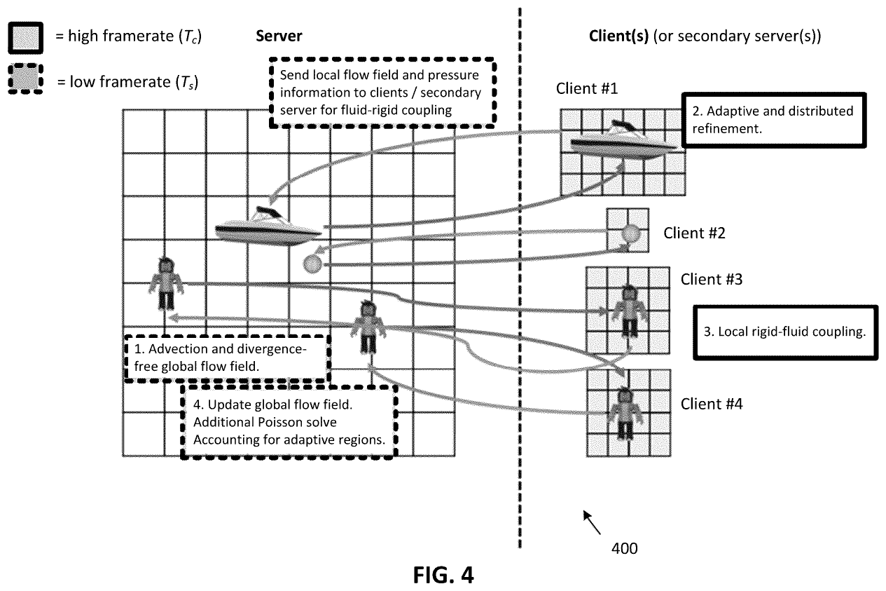

FIG. 4 is a diagram illustrating an example of a method 400 for providing adaptive, distributed simulation of fluids with rigid body coupling, in accordance with some implementations. The diagram illustrates a distributed architecture in which a server coordinates the global fluid simulation, while multiple client devices or secondary servers handle localized, high-resolution simulations in regions requiring detailed interaction between fluids and rigid bodies. The illustration highlights the division of labor between the server and clients, as well as the data flow between these entities to maintain a coherent and accurate simulation across the entire virtual environment.

On the left side of FIG. 4, the server is shown managing the global fluid simulation. The global flow field is represented as a grid, with each cell corresponding to a region of the simulated environment. The server performs the primary simulation tasks, including advection and the computation of a divergence-free velocity field, which is necessary for maintaining the incompressibility of the fluid. This process is depicted in step 1 of the diagram. The server operates at a lower framerate, denoted as Ts, which allows it to efficiently handle the large-scale fluid dynamics that define the overall behavior of the fluid across the entire environment. The server also processes the data received from the clients to update the global flow field, as indicated in step 4.

The server sends subsets of the global fluid simulation data to the client devices. These subsets correspond to regions where additional detail is needed, particularly around rigid bodies such as characters, vehicles, or objects interacting with the fluid. The server selects these regions based on various criteria, such as changes in fluid dynamics or the proximity of rigid objects to certain grid points. The server then transmits the relevant flow field and pressure information to the client devices, as depicted by the arrows connecting the server to the clients.

On the right side of FIG. 4, multiple client devices are shown, each responsible for simulating a specific region of the fluid with a higher degree of accuracy. These regions are represented by finer grids on the client side, indicating that the client simulations operate at a higher spatial resolution compared to the global simulation. The client devices perform two tasks: adaptive and distributed refinement (step 2) and local rigid-fluid coupling (step 3). The adaptive refinement involves increasing the resolution of the simulation in regions of interest, such as around a boat or a character, to capture finer details of fluid behavior. The local rigid-fluid coupling simulates the interactions between the fluid and rigid bodies, calculating forces and torques that influence both the fluid and the objects.

The diagram emphasizes that the client simulations run at a higher framerate, denoted as Tc, which is necessary to capture the rapid dynamics of the fluid in these refined regions. This higher temporal resolution allows the clients to resolve the detailed fluid-rigid interactions with greater accuracy, ensuring that the simulated behavior of both the fluid and the rigid objects is realistic and responsive. After completing their simulations, the client devices send the refined simulation data back to the server. This data includes updated velocity and pressure fields, which the server then integrates into the global flow field to maintain the overall consistency of the simulation.

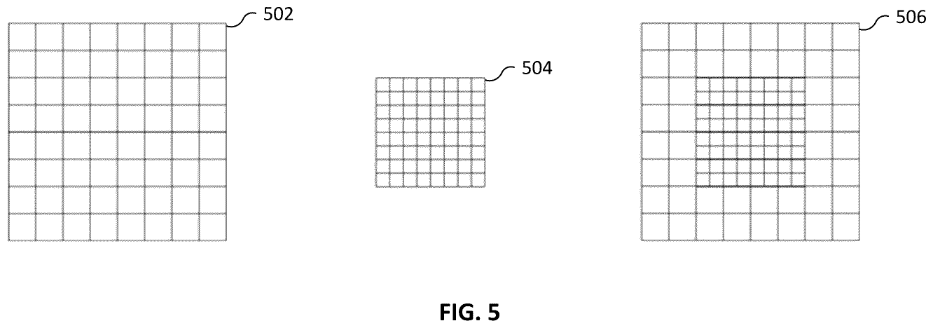

FIG. 5 is a diagram illustrating an example of an adaptive multigrid structure, in accordance with some implementations. The diagram illustrates the different levels of grid refinement used in the distributed simulation of fluids with rigid body coupling. The diagram shows three main components: the global grid managed by the server, a refined local patch handled by a client, and an adaptive multigrid structure that integrates these components within the heterogeneous computing system.

On the left side of FIG. 5, the global grid 502 is illustrated, hosted by the server. This grid spans the entire simulation domain and is responsible for simulating large-scale fluid dynamics across the virtual environment. The grid is depicted as a coarse resolution grid, where each cell represents a relatively large volume of fluid. This coarse grid allows the server to efficiently compute the global flow field, including broad fluid behaviors such as wave propagation and general flow patterns. The global grid operates with lower spatial and temporal resolution compared to the local grids handled by client devices, which focus on specific regions requiring additional detail.

In the center of FIG. 5, a refined local patch 504 is illustrated, running on a client device. This patch represents a region within the global grid that has been identified as needing higher resolution due to the presence of complex fluid dynamics or interactions with rigid bodies. The refined patch is a smaller grid with higher spatial resolution, meaning that each cell within this patch represents a smaller volume of fluid compared to the global grid. This increased resolution allows the client to accurately simulate fine-scale fluid behaviors, such as detailed interactions between fluids and rigid objects, turbulence, or small-scale waves. The client device computes the fluid dynamics within this patch, focusing on the specific region of interest while communicating the refined results back to the server.

On the right side of FIG. 5, an adaptive multigrid structure 506 is illustrated, distributed across the heterogeneous system. This structure integrates the global grid managed by the server with the refined local patches handled by the client devices. The adaptive multigrid structure dynamically adjusts the resolution of the simulation grid based on the requirements of the simulation. Regions of the grid that involve complex interactions or require higher accuracy are refined, while other regions may remain coarse to conserve computational resources. The adaptive multigrid approach allows the system to balance the need for detailed simulation in critical areas with the overall performance of the simulation across the entire domain.

The adaptive multigrid structure also facilitates the communication and synchronization between the global grid and the refined local patches. The server and client devices exchange data to ensure that the local simulations remain consistent with the global flow field and that any changes in the local patches are accurately reflected in the global simulation. This process may involve interpolating data between grids of different resolutions, applying boundary conditions, and ensuring that the simulation remains physically accurate across the entire domain.

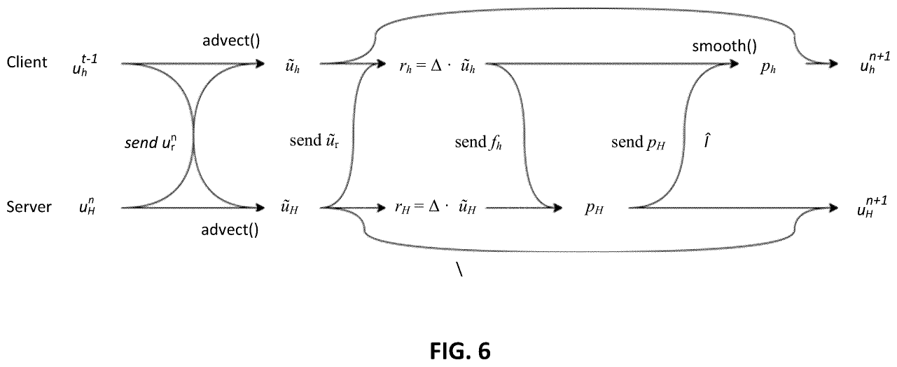

FIG. 6 is a diagram illustrating an example of a dataflow of a multigrid process used to solve for a divergence-free flow field, in accordance with some implementations. The diagram illustrates the communication and computation steps between a client device and a server as they collaborate to maintain a consistent and physically accurate simulation of fluid dynamics.

The diagram is divided into two horizontal sections, with the upper section representing the operations performed on the client side and the lower section representing the operations on the server side. At the beginning of the dataflow, both the client and the server start by performing an advection operation on their respective velocity fields, denoted as un for the client and un for the server. The advection operation updates the fluid's velocity based on its previous state, accounting for the transport of fluid properties through the velocity field. This operation is critical for simulating the movement of fluid within both the global and local grids.

Following the advection step, the client and server independently calculate the residuals, rₕ and r_{H}, which represent the divergence of the velocity fields after advection. These residuals are used for identifying the extent to which the velocity fields deviate from being divergence-free, which indicates areas where the fluid's incompressibility condition has been violated. The residuals are computed using a differential operator, represented by Δ, which approximates the divergence within each grid cell. The computed residuals provide the necessary information for the next step in the multigrid process.

After calculating the residuals, the client sends its velocity field, ũₕ, to the server. The server uses this data to inform its next steps in maintaining consistency between the global and local simulations. Similarly, the server sends its computed residual, fₕ, back to the client. This exchange of information ensures that both the client and the server are synchronized in their understanding of the fluid dynamics within their respective grids, allowing them to collaboratively work towards a divergence-free solution.

The server then solves for the pressure field, p_{H}, based on the residuals computed earlier. The pressure field is a scalar field that, when applied to the velocity field, corrects any divergence, effectively enforcing the incompressibility of the fluid. Once the server computes the pressure field, it sends this data back to the client. The client, in turn, interpolates this pressure field and applies a smoothing operation, denoted as smooth( ), to refine the pressure field within the local grid, resulting in a pressure field pₕ.

Finally, both the client and the server use their respective pressure fields to update the velocity fields to the next timestep, denoted as uₕⁿ⁺¹ for the client and u_{H}ⁿ⁺¹ for the server. This update ensures that the velocity fields are divergence-free, thus maintaining the incompressibility of the fluid. The iterative nature of this dataflow, with continuous communication and adjustment between the client and server, enables the system to maintain a consistent and accurate fluid simulation across both global and local grids. The diagram encapsulates the collaborative process between client and server in solving the fluid dynamics problem, leveraging the multigrid approach to achieve high-fidelity simulation results. INVENTORS IS THIS CORRECT?

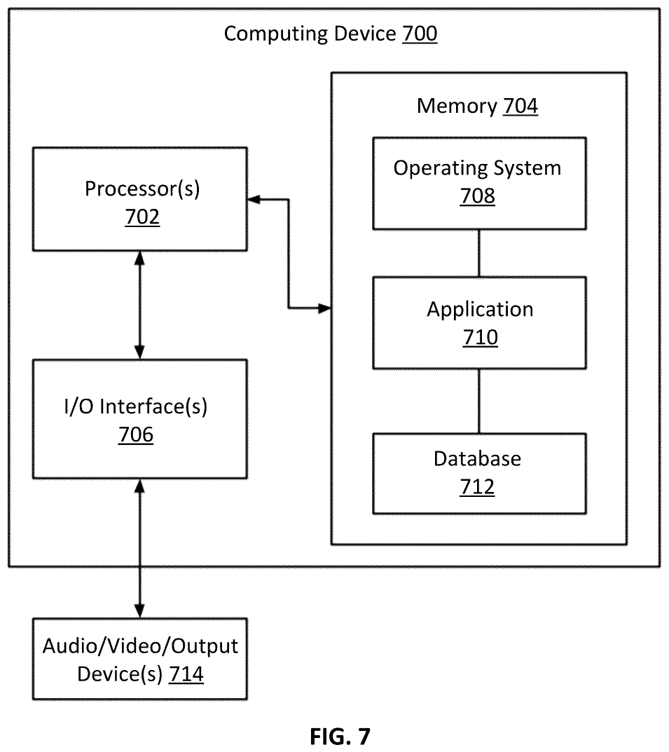

### FIG. 7—Computing Device

FIG. 7 is a block diagram of an example computing device 700 which may be used to implement one or more techniques described herein. In one example, device 700 may be used to implement a computer device (e.g., 102 and/or 110 of FIG. 1), and perform appropriate method implementations described herein. Computing device 700 can be any suitable computer system, server, or other electronic or hardware device. For example, the computing device 700 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 700 includes a processor 702, a memory 704, input/output (I/O) interface 706, and audio/video input/output devices 714.

Processor 702 can be one or more processors and/or processing circuits to execute program code and control basic operations of the device 700. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 704 is typically provided in device 700 for access by the processor 702, and may be any suitable computer-readable or processor-readable storage medium, e.g., random access memory (RAM), read-only memory (ROM), Electrical Erasable Read-only Memory (EEPROM), Flash memory, etc., suitable for storing instructions for execution by the processor, and located separate from processor 702 and/or integrated therewith. Memory 704 can store software operating on the server device 700 by the processor 702, including an operating system 708, one or more applications 710, and a database 712 that may store data used by the components of device 700. In some implementations, applications 710 can include instructions that enable processor 702 to perform the functions (or control the functions of) described herein, e.g., some or all of the methods described with respect to FIG. 2. For example, applications 710 can include a module that implements one or more machine learning models used in techniques described herein, e.g., learned diffusion layers such as DiffusionNet, multi-layer perceptron, PointNet, or transformer self-attention layers. Applications 710 can include one or both of the loss functions of FIG. 3, that is, a) a squared L2-difference in the size similarity between the prediction and the ground truth, and/or b) a squared L2-difference in the directional similarity between the prediction and the ground truth. Database 712 (and/or other connected storage) can store various data used in described techniques, including input meshes of an avatar, quad meshes, output retopologized meshes, features 306, barycenters, local coordinate frames, etc.

Elements of software in memory 704 can alternatively be stored on any other suitable storage location or computer-readable medium. In addition, memory 704 (and/or other connected storage device(s)) can store instructions and data used in the features described herein. Memory 704 and any other type of storage (magnetic disk, optical disk, magnetic tape, or other tangible media) can be considered “storage” or “storage devices.”

I/O interface 706 can provide functions to enable interfacing the server device 700 with other systems and devices. For example, network communication devices, storage devices (e.g., memory and/or data store 120), and input/output devices can communicate via interface 706. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 714 can a variety of devices including a user input device (e.g., a mouse, etc.) that can be used to receive user input, audio output devices (e.g., speakers), and a display device (e.g., screen, monitor, etc.) and/or a combined input and display device, which can be used to provide graphical and/or visual output.

For case of illustration, FIG. 7 shows one block for each of processor 702, memory 704, I/O interface 706, and software blocks of operating system 708 and virtual experience application 710. These blocks may represent one or more processors or processing circuitries, operating systems, memories, I/O interfaces, applications, and/or software engines. In other implementations, device 700 may not have all of the components shown and/or may have other elements including other types of elements instead of, or in addition to, those shown herein. While the online virtual experience server 102 is described as performing operations as described in some implementations herein, any suitable component or combination of components of online virtual experience server 102, client device 110, or similar system, or any suitable processor or processors associated with such a system, may perform the operations described.

Device 700 can be a server device or client device. Example client devices or user devices can be computer devices including some similar components as the device 700, e.g., processor(s) 702, memory 704, and I/O interface 706. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 714, for example, can be connected to (or included in) the device 700 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 200 and other described techniques) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, blocks, operations, or computations may be presented in a specific order, the order may be changed in different particular implementations. In some implementations, multiple steps or operations shown as sequential in this specification may be performed at the same time.

1. A computer-implemented method comprising:
simulating, with a coarse resolution on one or more server devices, a global flow field for a fluid within a virtual environment, wherein the server devices execute a global fluid simulation within the virtual environment, the global fluid simulation is executed for a grid that represents the virtual environment, and an output of the global fluid simulation is a set of fluid simulation data relating to the fluid;
determining a plurality of regions within the grid to obtain additional detail for, the determining being based on a presence of one or more rigid objects within the virtual environment;
for each of the plurality of regions:
assigning one or more client devices from a plurality of client devices to the region;
sending, from the one or more server devices, the fluid simulation data pertaining to the region to the one or more client devices; and
receiving, at the one or more server devices, refined fluid simulation data for the region from the one or more client devices;
replacing the fluid simulation data in the global fluid simulation pertaining to the plurality of regions with the refined fluid simulation data for the plurality of regions; and
after the replacing, updating, at the one or more server devices, the global flow field for the fluid in real time based on the simulation data.

2. The computer-implemented method of claim 1, further comprising:
identifying one or more overlapping regions with more than one set of the refined fluid simulation data; and
interpolating the refined fluid simulation data in the overlapping regions based on residuals of the refined fluid simulation data of the overlapping regions.

3. The computer-implemented method of claim 1, wherein assigning the one or more client devices from the plurality of client devices to the region is performed based on one or more of: a location of an avatar controlled by a player associated with the client devices, and a proximity of one or more of the rigid objects to the avatar.

4. The computer-implemented method of claim 1, wherein the refined fluid simulation data comprises data computed via a local flow field with a finer resolution than the coarse resolution for the global flow field.

5. The computer-implemented method of claim 1, wherein the refined fluid simulation data comprises data computed via one or more advection operations and divergence-free operations.

6. The computer-implemented method of claim 5, wherein the one or more advection operations comprises:
utilizing a level set to determine fluid boundaries, wherein the one or more advection operations are within the determined fluid boundaries.

7. The computer-implemented method of claim 1, wherein the refined fluid simulation data comprises data computed via one or more fluid-rigid coupling effects at a higher spatial resolution than that of the global fluid simulation.

8. The computer-implemented method of claim 1, wherein the refined fluid simulation data comprises data computed with one or more pressure forces and one or more collision forces of the fluid on the rigid objects based on a geometry and motion of the rigid objects within the region.

9. The computer-implemented method of claim 1, wherein the determination of regions to obtain additional detail for is based on one or more of: detecting changes in fluid dynamics, and detecting a proximity of the rigid objects within the virtual environment to one or more points on the grid.

10. The computer-implemented method of claim 1, wherein the client devices and the one or more server devices operate according to timesteps, and wherein the client devices execute multiple simulation steps per one server timestep to enable a higher temporal resolution in local fluid simulations.

11. The computer-implemented method of claim 1, wherein computing the refined fluid simulation data comprises calculating torque and pressure differentials on the rigid objects based on the fluid simulation data.

12. A system comprising:
one or more processors; and
memory coupled to the one or more processors storing instructions that, when executed by the one or more processors, cause the system to perform operations comprising:
simulating, with a coarse resolution on one or more server devices, a global flow field for a fluid within a virtual environment, wherein the server devices execute a global fluid simulation within the virtual environment, the global fluid simulation is executed for a grid that represents the virtual environment, and an output of the global fluid simulation is a set of fluid simulation data relating to the fluid;
determining a plurality of regions within the grid to obtain additional detail for, the determining being based on a presence of one or more rigid objects within the virtual environment;
for each of the plurality of regions:
assigning one or more client devices from a plurality of client devices to the region;
sending, from the one or more server devices, the fluid simulation data pertaining to the region to the one or more client devices; and
receiving, at the one or more server devices, refined fluid simulation data for the region from the one or more client devices;
replacing the fluid simulation data in the global fluid simulation pertaining to the plurality of regions with the refined fluid simulation data for the plurality of regions; and
after the replacing, updating, at the one or more server devices, the global flow field for the fluid in real time based on the simulation data.

13. The system of claim 12, wherein the system performs operations further comprising:
identifying one or more overlapping regions with more than one set of refined fluid simulation data; and
interpolating the refined fluid simulation data in the overlapping regions based on the residuals of the refined fluid simulation data of the overlapping regions.

14. The system of claim 12, wherein assigning one or more client devices from the plurality of client devices to the region is performed based on one or more of: the location of an avatar controlled by a player associated with the client, and the proximity of one or more of the rigid objects to the avatar.

15. The system of claim 12, wherein the refined fluid simulation data comprises data computed via a local flow field with a finer grid resolution than the coarse grid resolution for the global flow field.

16. The system of claim 12, wherein the refined fluid simulation data comprises data computed via one or more advection and divergence-free operations.

17. The system of claim 16, wherein the one or more advection operations comprises:
utilizing a level set to determine fluid boundaries, wherein the one or more advection operations are within the determined fluid boundaries.

18. The system of claim 12, wherein the refined fluid simulation data comprises data computed via one or more fluid-rigid coupling effects at a higher spatial resolution than that of the global fluid simulation.

19. The system of claim 12, wherein the refined fluid simulation data comprises data computed with one or more pressure forces and one or more collision forces of the fluid on the rigid objects based on the geometry and motion of the rigid objects within the region.

20. A non-transitory computer-readable medium with instructions stored thereon that, responsive to execution by a processing device, causes the processing device to perform operations comprising:
simulating, with a coarse resolution on one or more server devices, a global flow field for a fluid within a virtual environment, wherein the server devices execute a global fluid simulation within the virtual environment, the global fluid simulation is executed for a grid that represents the virtual environment, and an output of the global fluid simulation is a set of fluid simulation data relating to the fluid;
determining a plurality of regions within the grid to obtain additional detail for, the determining being based on a presence of one or more rigid objects within the virtual environment;
for each of the plurality of regions:
assigning one or more client devices from a plurality of client devices to the region;
sending, from the one or more server devices, the fluid simulation data pertaining to the region to the one or more client devices; and
receiving, at the one or more server devices, refined fluid simulation data for the region from the one or more client devices;
replacing the fluid simulation data in the global fluid simulation pertaining to the plurality of regions with the refined fluid simulation data for the plurality of regions; and
after the replacing, updating, at the one or more server devices, the global flow field for the fluid in real time based on the simulation data.
